(19) United States
(12) Patent Application Publication
(10) Pub. No.: US 2026/0111270 A1
(43) Pub. Date: Apr. 23, 2026

(54) SCOPE PREDICTION FOR MULTI-DRAWER SYSTEM

(71) Applicant: International Business Machines Corporation, Armonk, NY (US)

(72) Inventors: Vesselina Papazova, Poughkeepsie, NY (US); Robert J. Sonnelitter, III, POUGHKEEPSIE, NY (US); Craig R. Walters, Poughkeepsie, NY (US); Avery Francois, POUGHKEEPSIE, NY (US); Mike Chow, POUGHKEEPSIE, NY (US); James Franklin Driftmyer, Endicott, NY (US)

(21) Appl. No.: 18/918,763

(22) Filed: Oct. 17, 2024

(51) Int. Cl. G06F 9/50; H04L 67/10

(52) U.S. Cl. CPC G06F 9/5027; H04L 67/10

(57) ABSTRACT

An example operation may include one or more of receiving a data request for a partition by a requesting chip within a drawer of a multi-drawer system, determining that the data request cannot be satisfied by any chips within the drawer, incrementing a value of a counter associated with the partition, assigning resources to at least one pass-through chip within the drawer for broadcasting the data request to at least one other drawer of the multi-drawer system, receiving an additional data request for the partition, and in response to the value of the counter being at a predetermined threshold value, proactively assigning additional resources to the at least one pass-through chip for broadcasting the additional request to the at least one other drawer in the multi-drawer system prior to determining whether the additional data request can be satisfied by any of the chips within the drawer.

### BACKGROUND

Highly-distributed systems such as multi-drawer processing systems within multiple processing chips in each drawer, follow a multi-scope coherency protocol. In this protocol, a data request is initiated within a processing chip inside a first drawer. Initially, the processing chip is checked for the data. If the data is not found there, the other chips within the drawer are then checked (expanded scope). If the data is still not found, the search is expanded to chips within other drawers (further expanded scope) of the system. This process requires significant communication among the chips inside the system, which creates latency in the overall processing time of the data request.

### SUMMARY

One example embodiment provides an apparatus that may include a memory and at least one processor communicably coupled to the memory, where the at least one processor may be configured to perform one or more of receive a data request for a partition within a drawer of a multi-drawer system, determine that the data request cannot be satisfied by any chips within the drawer of the multi-drawer system, increment a value of a counter associated with the partition, assign resources to at least one pass-through chip within the drawer for broadcasting the data request to at least one other drawer of the multi-drawer system, receive an additional data request for the partition, and in response to the value of the counter being at a predetermined threshold value, proactively assign additional resources to the at least one pass-through chip for broadcasting the additional data request to the at least one other drawer in the multi-drawer system prior to determining whether the additional data request can be satisfied by any chips within the drawer.

Another example embodiment provides a method that may include one or more of receiving a data request for a partition within a drawer of a multi-drawer system, determining that the data request cannot be satisfied by any chips within the drawer of the multi-drawer system, incrementing a value of a counter associated with the partition, assigning resources to at least one pass-through chip within the drawer for broadcasting the data request to at least one other drawer of the multi-drawer system, receiving an additional data request for the partition, and in response to the value of the counter being at a predetermined threshold value, proactively assigning additional resources to the at least one pass-through chip for broadcasting the additional data request to the at least one other drawer in the multi-drawer system prior to determining whether the additional data request can be satisfied by any chips within the drawer.

A further example embodiment provides a computer-readable hardware storage medium that includes instructions which when executed by a processor may cause the processor to perform one or more of receiving a data request for a partition within a drawer of a multi-drawer system, determining that the data request cannot be satisfied by any chips within the drawer of the multi-drawer system, incrementing a value of a counter associated with the partition, assigning resources to at least one pass-through chip within the drawer for broadcasting the data request to at least one other drawer of the multi-drawer system, receiving an additional data request for the partition, and in response to the value of the counter being at a predetermined threshold value, proactively assigning additional resources to the at least one pass-through chip for broadcasting the additional data request to the at least one other drawer in the multi-drawer system prior to determining whether the additional data request can be satisfied by any chips within the drawer.

### BRIEF DESCRIPTION OF THE DRAWINGS

FIG. 1 is a diagram illustrating a computing environment according to an embodiment of the instant solution.

FIG. 2A is a diagram illustrating a process of snooping for data within a multi-drawer system according to the examples and features of the instant solution.

FIG. 2B is a diagram illustrating an additional process of snooping for data within the multi-drawer system according to the examples and features of the instant solution.

FIG. 2C is a diagram illustrating a sequence of communications for performing the snooping process according to examples and features of the instant solution.

FIG. 3 is a diagram illustrating a table of a predictive system according to the examples and features of the instant solution.

FIG. 4 is a diagram illustrating a process of snooping for data within a multi-drawer system using a predictive system according to the examples and features of the instant solution.

FIG. 5A is a diagram illustrating a flow diagram according to example embodiments.

FIG. 5B is a diagram illustrating a flow diagram according to example embodiments.

### DETAILED DESCRIPTION

It is to be understood that although this disclosure includes a detailed description of cloud computing, implementation of the teachings recited herein is not limited to a cloud computing environment. Rather, embodiments of the instant solution are capable of being implemented in conjunction with any other type of computing environment now known or later developed.

A multi-drawer processing system includes multiple drawers with processing modules inside each drawer. Each processing module may include a plurality of chips therein which each contain a plurality of caches for storing data. When a data request is received by a processing chip (referred to as a requesting chip), the caches of the requesting chip are first checked for the requested data. This operation is referred to as a “snoop” operation. If the requested data is not found within the caches of the requesting chip, the scope of the snoop is expanded to include other chips in the same drawer. Here, the requesting chip forwards the data request to the other chips in the drawer and a snoop of the caches of the other chips in the same drawer is performed to determine if any of the caches contain the requested data.

If the data is still not found, the snoop operation expands to the other drawers within the multi-drawer system. Here, the data request is broadcast from chips in the drawer to other chips in other drawers. The chips that transfer the data request from one drawer to another are referred to as “pass-through” chips. Before a data request can be forwarded to another drawer, a pass-through chip requires resources. For example, in order to access data from caches or main memory on the remote drawer, the requester needs to be assigned resources such as a set of controllers on that drawer that can return data and ensure coherency protection of the data while it is in flight.

The memory may have stale data relative to a cached copy of the data. The requester may need to acquire access to the latest copy of the data from the cache. To ensure coherency of the data the controllers in charge of the operation need to ensure that any other data request in flight for the same data observe the data movement within the current scope. For example, if the data moves from one chip cache to another chip cache within a drawer, any data request in flight on that drawer needs to observe the data movement. Similarly, if the data moves between drawers all outstanding requesters for that data need to observe the data movement. To ensure observability of the data movement, the operation needs to acquire the necessary resources for the next scope before broadcasting the request in that scope.

However, the controllers and other resources for observing data movement aren't assigned until after a determination is made to send the data request “off-drawer” by the requesting chip. In particular, the requesting chip notifies a resource management chip within the drawer that the snoop must expand “off-drawer”, and the resource management chip then assigns resources to the pass-through chips and forward the resources to the pass-through chips before the data request can be forward “off-drawer” to the other drawers. This process requires significant overhead between the chips of the multi-drawer system resulting in latency being added to the initial data request.

Some coherency protocols require the resource allocation to the next scope to be managed by a single chip in a multi-chip distributed system with multiple pass-through chips connecting to the next scope. It can take extra time for the current scope results to arrive at the resource management chip so the resources for the next scope are assigned and the pass-through chips are notified of the resource availability. This leads to longer controller utilization times and higher latencies on operations that need to advance to higher scope.

The example embodiments are directed to a predictive system which can predict when a data request will need to go off-drawer prior to the requesting chip determining receiving response from the other chips in the drawer confirming that the data request will need to go off drawer. Here, the predictive system may include a table that keeps track of (i.e., counts) off-drawer data requests associated with a particular operation, partition, etc. When the count of off-drawer requests reaches a predetermined threshold, the requesting chip can predict with reasonable certainty that the next request from the same operation, partition, etc. will also need to go off-drawer, prior to performing the snoop of the chips in the drawer. Here, the requesting chip can set a bit or otherwise notify the other chips in the drawer of the likely need to go off-drawer when sending the initial data requests to the chips in the drawer.

This enables the resource management chip to detect the likely need for resources ahead of time. Accordingly, the resource management chip can assign resources to the pass-through chips ahead of time, enabling the pass-through chips to forward the data request to the other drawers as soon as the requesting chip determines the data is not located in the drawer. In particular, the requesting chip does not need to notify the resource management chip, and the resource management chip does not need to assign resources “after-the-fact” because the resources have already been assigned. The benefit of this system is that the latency for processing the initial data request is significantly reduced when the data request needs to go “off-drawer” to find the data.

In some embodiments, each type of operation on a different originating partition (e.g., requesting unit, processing core, thread, channel, stream, etc.) can have its own counter/table for predicting off-drawer likelihood. This is accomplished by building a table where each entry represents a small counter per requesting partition. The counter is incremented each time there is a need for wider scope (off-drawer) and decremented when the scope is not expanded off-drawer in cases where the data is found in the initial drawer. If the counter reaches a threshold value (e.g., ten, fifteen, twenty, etc.) the system can predict with confidence that future operations from the same partition will need to advance to the next scope.

When the resource for the next scope is limited, the prediction can be used to assign the resource before the results from the current scope are available. If the prediction is correct the operation can proceed to the next scope as soon as the current scope results arrive at pass-through chips and the coherency interlock in the current scope has been established successfully. If the prediction is unsuccessful the predictor can adjust its behavior for future operations and the resource management chip can assign the unused resource right away. The associated bit in the requester vector for the partition can be reset on failed advancement prediction or set if scope advancement is needed. No additional communication between resource management and pass-through chips will be required for failed prediction. Hot lines that normally have longer tenure within the current scope can be filtered out and not affect the prediction table or be assigned a resource speculatively.

In a multi-drawer system, certain operations often “bleed” into other drawers of the multi-drawer system. The example embodiments can limit the latency caused by such bleeding through the use of the predictive system. In particular, after a few similar requests are identified as needing to go off-drawer, the system can predict with confidence that future similar request will also need to go off-drawer, thereby ensuring that processing latency for these subsequent requests is reduced.

The example embodiments implement a coherency protocol with built in scope progression predictor used to preemptively assign resources for the next coherency scope in a highly distributed system with centralized resource management and distributed connectivity to the next coherency scope. The system also includes a partition-based history table used to predict a need for scope progression in multi-scope coherency protocol. Here, the algorithm can be applied in a system with multi-scope coherency protocol as the prediction can be completed at different scope levels if needed.

The multi-drawer system described herein may be implemented within a host platform such as a mainframe computer, a cloud platform, a web server, a database, or the like.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:
On-demand self-service: a cloud consumer can unilaterally provision computing capabilities, such as server time and network storage, as needed automatically without requiring human interaction with the service's provider.
Broad network access: capabilities are available over a network and accessed through standard mechanisms that promote use by heterogeneous thin or thick client platforms (e.g., mobile phones, laptops, and PDAs).
Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or data center).
Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.
Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:
Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure, including network, servers, operating systems, storage, or even individual application capabilities, with the possible exception of limited user-specific application configuration settings.
Platform as a Service (PaaS): the capability provided to the consumer is to deploy onto the cloud infrastructure consumer-created or acquired applications created using programming languages and tools supported by the provider. The consumer does not manage or control the underlying cloud infrastructure, including networks, servers, operating systems, or storage, but has control over the deployed applications and possibly application hosting environment configurations.
Infrastructure as a Service (IaaS): the capability provided to the consumer is to provision processing, storage, networks, and other fundamental computing resources where the consumer can deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:
Private cloud: the cloud infrastructure is operated solely for an organization. It may be managed by the organization or a third party and may exist on-premises or off-premises.
Community cloud: the cloud infrastructure is shared by several organizations and supports a specific community with shared concerns (e.g., mission, security requirements, policy, and compliance considerations). It may be managed by organizations or a third party and may exist on-premises or off-premises.
Public cloud: the cloud infrastructure is made available to the general public or a large industry group and is owned by an organization selling cloud services.
Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service-oriented with a focus on statelessness, low coupling, modularity, and semantic interoperability. At the heart of cloud computing is an infrastructure that includes a network of interconnected nodes.

The instant features, structures, or characteristics as described throughout this specification may be combined or removed in any suitable manner in one or more embodiments. For example, the usage of the phrases “example embodiments,” “some embodiments,” or other similar language, throughout this specification refers to the fact that a particular feature, structure, or characteristic described in connection with the embodiment may be included in at least one embodiment. Thus, appearances of the phrases “example embodiments,” “in some embodiments,” “in other embodiments,” or other similar language, throughout this specification do not necessarily all refer to the same group of embodiments, and the described features, structures, or characteristics may be combined or removed in any suitable manner in one or more embodiments. Further, in the diagrams, any connection between elements can permit one-way and/or two-way communication even if the depicted connection is a one-way or two-way arrow. Also, any device depicted in the drawings can be a different device. For example, if a mobile device is shown sending information, a wired device could also be used to send the information.

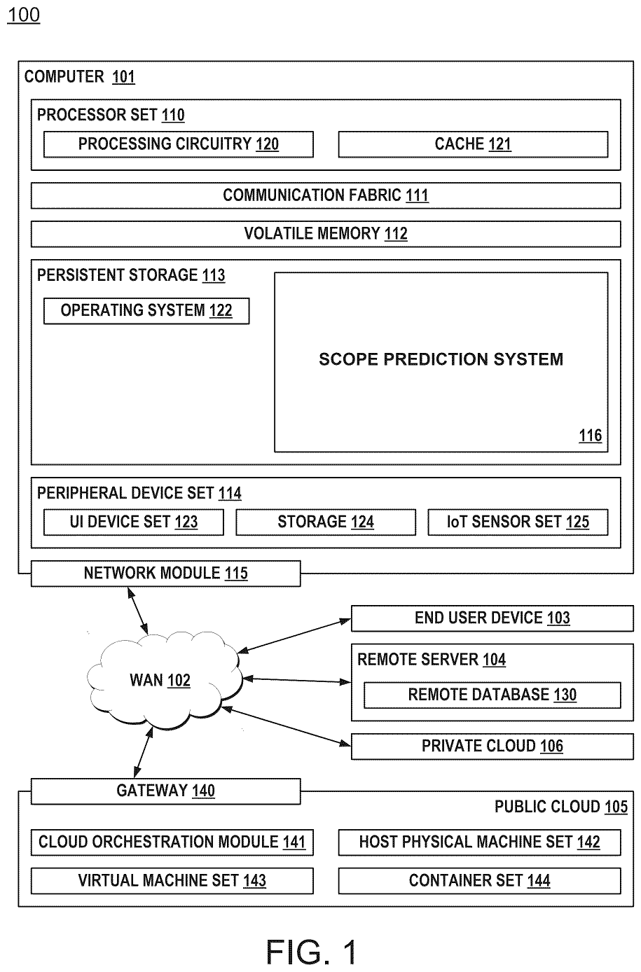

FIG. 1 illustrates a computing environment 100 according to an embodiment of the instant solution. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again, depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Referring to FIG. 1, computing environment 100 contains an example of an environment for executing at least some of the computer code involved in performing the inventive methods, such as a scope prediction system 116. In addition to block 116, computing environment 100 includes, for example, computer 101, wide area network (WAN) 102, end-user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 116, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smartphone, smartwatch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, the performance of a computer-implemented method may be distributed among multiple computers and/or between multiple locations. On the other hand, in this presentation of the computing environment 100, a detailed discussion is focused on a single computer, specifically the computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is a memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off-chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 116 in persistent storage 113.

COMMUNICATION FABRIC 111 is the signal conduction path that allows the various components of computer 101 to communicate with each other. Typically, this fabric comprises switches and electrically conductive paths, such as the switches and electrically conductive paths that make up buses, bridges, physical input/output ports, and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read-only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 116 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth® connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smartwatches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi® signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data now known or to be developed in the future. In some embodiments, the WAN may be replaced and/or supplemented by local area networks (LANs) designed to communicate data between devices located in a local area, such as a Wi-Fi® network. The WAN and/or LANs typically include computer hardware such as copper transmission cables, optical transmission fibers, wireless transmission, routers, firewalls, switches, gateway computers, and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer, and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, this data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanations of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as communicating with WAN 102, in other embodiments, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both parts of a larger hybrid cloud.

The example embodiments are directed to a multi-drawer system such as a processing system for a mainframe computer, cloud platform, web server, database, distributed systems, and the like. The multi-drawer system includes a plurality of drawers. Each drawer includes a plurality of processing cores or modules, and each core includes a plurality of chips therein. Furthermore, each chip includes a plurality of caches where data may be stored.

When a data request is received at the multi-drawer system, for example, from a software application, program, etc. which is hosted by a computing system of the multi-drawer system, the data request is processed by a requesting chip (e.g., the chip that received the data request). Here, the same chip may receive all data requests or different chips may receive different data requests. The data request may include an operation to be performed by a processing core along with data that needs to be used to perform the operation. The data may already be stored within a cache of the multi-drawer system.

Here, the requesting chip may initially determine whether the data needed by the request is stored within a cache of the requesting chip. If the data is not there, the requesting chip may forward the data request to the other chips in the same drawer. The other chips then respond (with responses) indicating whether or not the data is found in the other chips. The requesting chip combines the responses from the other chips to determine if the data is found (e.g., whether the request has been satisfied). If the data is found, the data is retrieved, and the operation is executed. However, if the data is not found in the drawer, the requesting chip determines to go “off-drawer” and forwards the combined responses to a resource management chip. The resource management chip assigns resources to pass-through chips within the drawer. The resource management chip then forwards the assigned resources to the pass-through chips. The pass-through chips then forward the data request to the other drawers using the assigned resources.

The example embodiments use tables to track count (increment, decrement, etc.) how often a data request goes “off-drawer”. When the count reaches a predetermined threshold value, the requesting chip can predict that a data request will go off-drawer before sending out the data request to the other chips in the drawer, and without needing to receive the responses from the other chips in the drawer. Thus, the requesting chip can notify the resource management chip of the likely “off-drawer” data request by setting a bit within the data request that is sent to the other chips in the drawer. In response to receiving the data request, the resource management chip can proactively assign resources to the pass-through chips and notify the pass-through chips of the assigned resources prior to the data request being determined as needing to go off-drawer. Thus, the latency of the process can be improved.

In the examples herein, the multi-drawer system is shown and described as including a plurality of drawers (e.g., at least three), where each drawer includes a plurality of processing modules (e.g., four processing modules per drawer, etc.) It should be appreciated that the number of drawers, the number of processing modules per drawer, the number of chips per processing module are not limited to the numbers shown in the figures and described herein. As another example, each drawer may only include two processing modules per drawer. As another example, each processing module may include four processing chips, etc. Other example implementations are also possible.

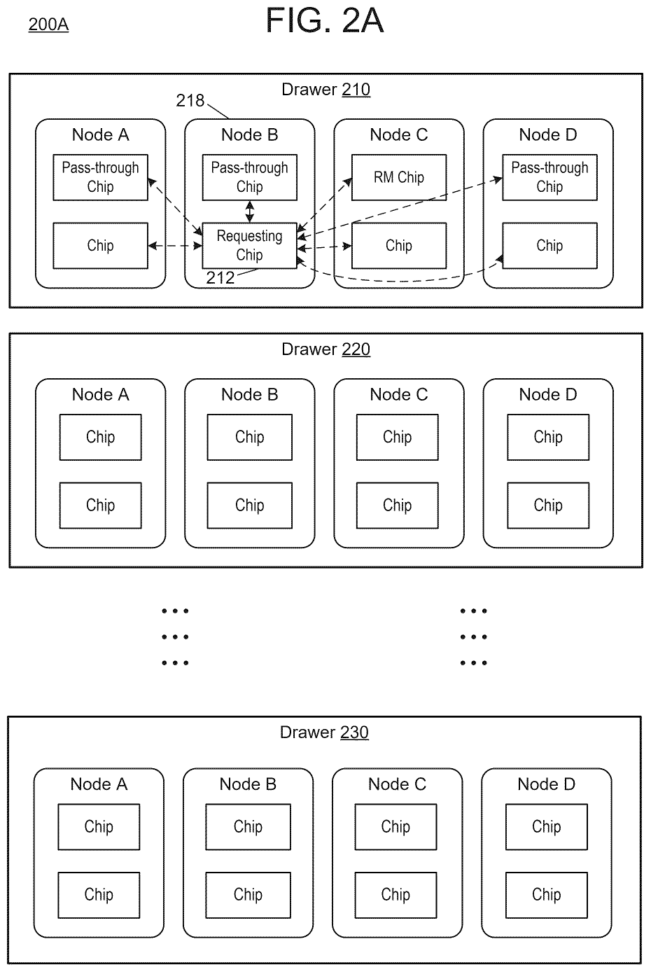

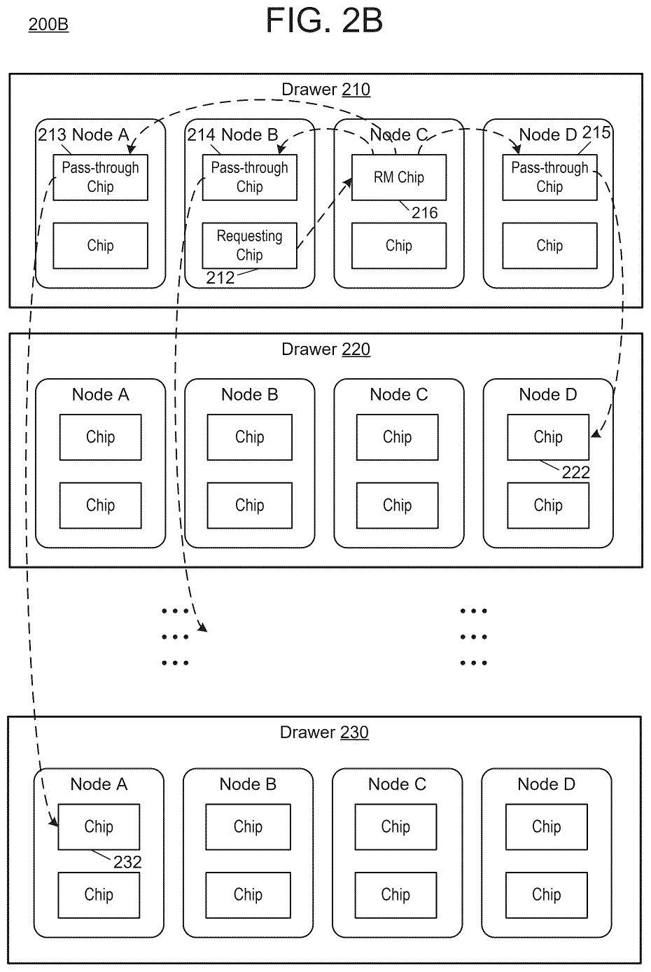

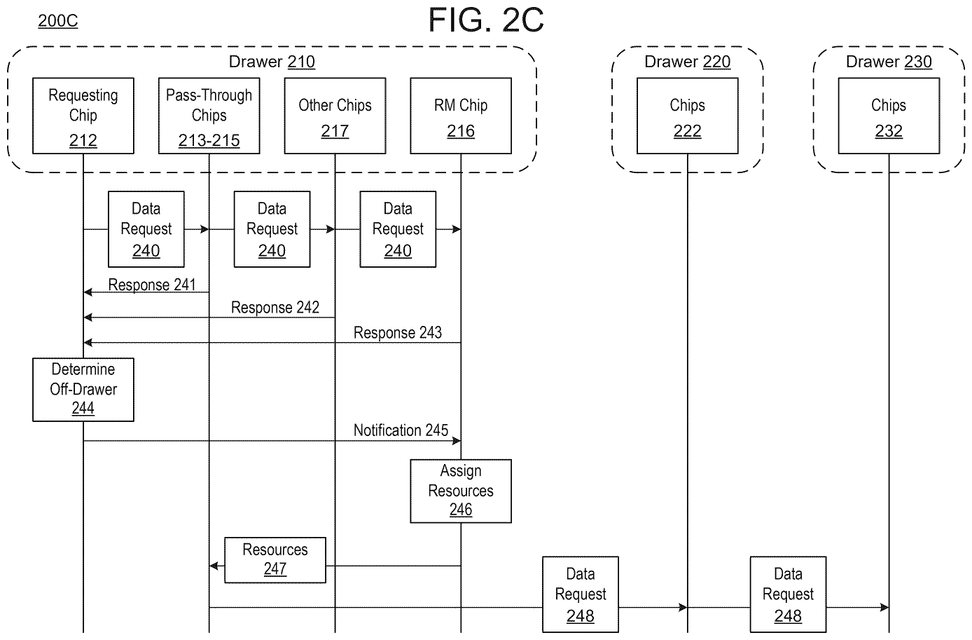

FIGS. 2A-2C illustrate an example of a processing system on a mainframe computer. The processing system may include multiple drawers, where each drawer includes a plurality of processing nodes (or cores). Each processing core includes one or more processing chips where data processing can take place. The processing chips also include cache memories and other storage elements where data used for processing is stored. During a task execution by the multi-drawer system shown in FIGS. 2A-2C, a processing request starts at a chip, within a processing core, within a drawer. The chip initially tries to find the data needed for the processing operation within its own local cache (first scope). If the chip cannot find the data, it then expands the search for the data to other processing chips in the same drawer (second scope). If the chip still cannot find the data in the drawer, the chip then expands the search to other drawers (third scop) in the multi-drawer system.

FIG. 2A illustrates a process 200A of snooping for data within a multi-drawer system according to the examples and features of the instant solution. Referring to FIG. 2A, a multi-drawer system is shown which includes a first drawer 210, a second drawer 220, and a third drawer 230. Each drawer includes a plurality of processing modules (e.g., cores). Inside each processing module is a plurality of chips (in this example two chips).

In the example of FIG. 2A, a processing request (e.g., from a software program) is received by a requesting chip 212 at a processing node 218 within the drawer 210. The processing request may include a request for a processing operation and data that is to be consumed by the processing operation. Here, the requesting chip 212 attempts to find the data needed for the processing operation within its local cache(s). That is, the requesting chip 212 determines whether the data needed by the processing operation is found within a cache of the requesting chip 212 by snooping for the data in its own local caches. If the data is found, the requesting chip 212 performs the processing operation using the found data. However, if the data is not found, the requesting chip 212 forwards the data request to all of the other chips in the drawer 210. This is referred to as expanding the scope of the search for the data.

Each of the chips in the drawer 210 then analyze their own caches to determine if the data is found therein. Each of the chips then generates a respective response and provides the response to the requesting chip 212. The responses indicate whether the data is found. The requesting chip 212 combines the responses from the other chips to determine whether the data is found. If the requesting chip 212 determines the data is still not found, the requesting chip 212 determines that the snooping process must go “off-drawer”.

FIG. 2B illustrates an additional process 200B of snooping for data within the multi-drawer system according to the examples and features of the instant solution. Referring to FIG. 2B, in this example, the requesting chip 212 has determined that the search for the data must go off-drawer. In this example, the requesting chip 212 combines the responses from all the chips in the drawer 210 and determines to go off-drawer. Next, the requesting chip 212 notifies a resource management chip 216 of the necessary off-drawer communications that need to be performed. In response, the resource management chip 216 acquires resources for broadcasting the data request off-drawer, and forwards the resources to pass-through chips 213, 214, and 215.

Each of the pass-through chips must wait for the resources before they can broadcast the data request to another drawer in the multi-drawer system. Here, the pass-through chip 213 may forward the data request to a chip 232 within the drawer 230. Likewise, the pass-through chip 214 may forward the data request to a chip within another drawer (not shown). Likewise, the pass-through chip 215 may forward the data request to a chip 222 within the drawer 220. Each of the pass-through chips 213, 214, and 215 may use the resources from the resource management chip 216 to forward the data request to the other drawers.

The chips on the other drawers (e.g., drawers 220 and 230, etc.) may check for the data included in the data request. If the data is found, the data is provided to the requesting chip 212 and the processing operation is executed. If the data is not found, the requesting chip 212 may access a main memory (not shown) for the data.

FIG. 2C illustrates a communication sequence 200C between chips within a multi-drawer system for performing the snooping process according to examples and features of the instant solution. FIG. 2C illustrates an example of the off-drawer snooping process that is performed by the multi-drawer system shown in the examples of FIGS. 2A and 2B. The sequence begins with the requesting chip 212 receiving a request to perform a data operation such as a processing operation. The operation requires data. Here, the requesting chip cannot find the data in a local cache (of the requesting chip 212). Therefore, in 240, the requesting chip 212 sends a data request to all of the other chips in the drawer 210 including the pass-through chips 213, 214, and 215, the resource management chip 216, and any other chips 217.

In 241, 242, and 243, the pass-through chips 213, 214, and 215, the resource management chip 216, and the other chips 217, response to the requests for data. In this example, the responses in 241, 242, and 243 indicate that the data cannot be found. The requesting chip 212 combines the responses and determines that the request needs to go off-drawer, in 244. In response, the requesting chip 212 combines the responses from all the chips in the drawer 210 and notifies the resource management chip 216 of the necessary off-drawer communications that need to be performed, in 245. In 246, the resource management chip 216 assigns resources for broadcasting the data request off-drawer to the pass-through chips 213, 214, and 215, and forwards the resources to pass-through chips 213, 214, and 215, in 247.

Each of the pass-through chips must wait for the resources before they can broadcast the data request to another drawer in the multi-drawer system. In 248, the pass-through chips 213, 214, and 215 forward the data request off-drawer to a chip 222 in the drawer 220 and a chip 232 in the drawer 230 using the resources assigned by the resource management chip 216. Here, the chip 222 may forward the data request to the other chips in the same drawer (i.e., the drawer 220), and the chip 232 may forward the data request to other chips in the same drawer (i.e., the drawer 230). If the data is found, it is returned back to the requesting chip 212 via the same path that the data request followed. If the data is not found, the data is pulled from main memory or the like.

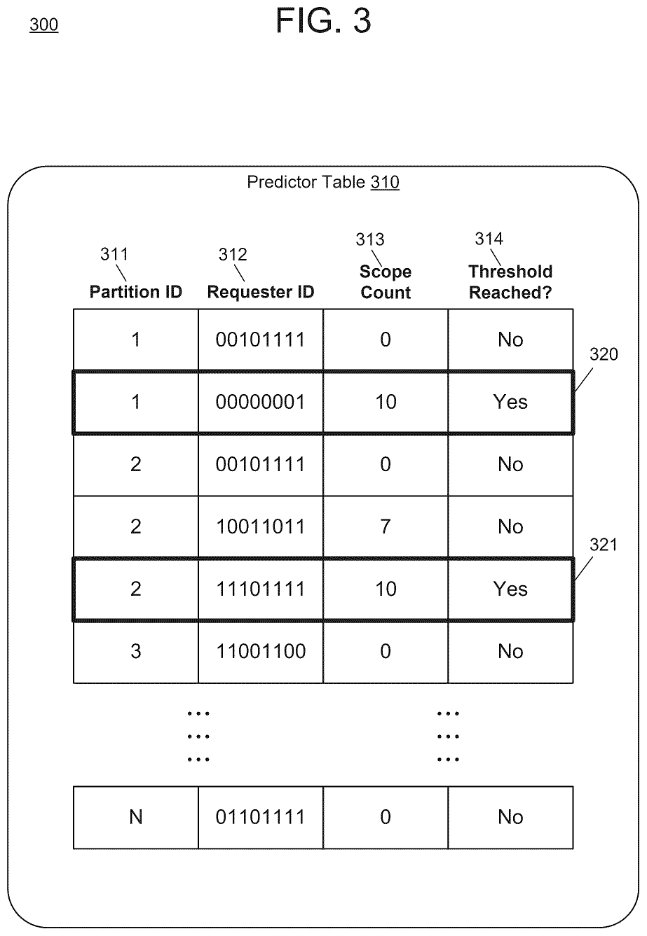

FIG. 3 illustrates a process 300 of managing a predictor table 310 of a predictive system according to the examples and features of the instant solution. For example, the predictor table 310 may be managed by the requesting chip 212 shown and described with respect to the examples of FIGS. 2A-2C. In this example, the predictor table 310 includes counts of off-drawer requests performed for different partitions of the system. For example, a first column 311 represents a partition identifier of a partition that requested the data, a second column 312 represents an identifier of an operation that requested the data, a column 313 represents a counter or scope count (which corresponds to off-drawer requests that result from the data request from the operation and the partition), and a column 314 indicating whether the counter in column 313 has reached a threshold value.

In some embodiments, the partition ID may be used to identify a component that requested the data, for example, a thread, a processing core, a channel, a stream, etc., and the requestor ID may correspond to a particular type of operation (e.g., core fetch, I/O fetch, I/O storing operation, etc.) Meanwhile, the scope count may be incremented each time a data request from a partition/requester pair requires an off-drawer snoop, and the scope count may be decremented each time a data request from the partition/operation pair is handled without going off-drawer.

According to various embodiments, the scope count may have a predetermined threshold, for example, ten, or the like. When the scope count reaches the threshold, the requesting chip automatically initiates a proactive assignment of resources to the pass-through chips of the drawer without waiting to receive responses from the chips in the drawer as to whether the data has been found or not in the drawer. That is, the requesting chip can predict that the request will require an off-drawer snoop due to the count reaching the predetermined threshold.

In the example of FIG. 3, a first entry 320 corresponds to a first partition/requester pair that have reached the scope count threshold, and a second entry 321 corresponds to a second partition/requester pair that have reached the scope count threshold.

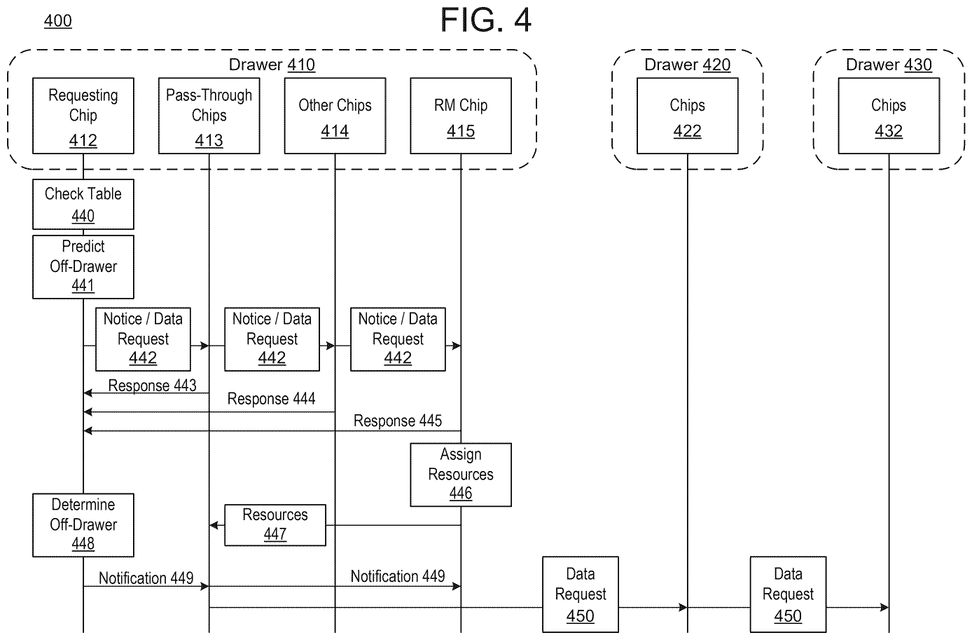

FIG. 4 illustrates a process 400 of snooping for data within a multi-drawer system using a predictive system according to the examples and features of the instant solution. The process 400 shown in FIG. 4 is similar to the communication sequence 200C shown in FIG. 2C, however, in this example, the requesting chip can set a bit in the initial data request to notify the other chips in the drawer that the data request is predicted to go “off-drawer” enabling the other chips to take proactive steps to reduce latency of the overall process.

Referring to FIG. 4, the sequence begins with a requesting chip 412 in a drawer 410 receiving a request to perform a data operation such as a processing operation. The operation requires data. In 440, the requesting chip 412 determines it cannot satisfy the request using any of its local caches and also checks a predictor table (such as the predictor table 310 shown in FIG. 3) and determines that the request is predicted to go “off-drawer”. For example, the data request may correspond to the partition ID/requestor ID included in the first entry 320 or the second entry 321 in the predictor table 310 of FIG. 3. In response, in 441, the requesting chip 412 modifies a bit of the data request to indicate the data request needs to go off-drawer and sends the modified data request to the other chips in the drawer 410 including pass-through chips 413, other chips 414, and a resource management chip 415.

In response, the pass-through chips 413, the other chips 414, and the resource management chip 415, provide responses 443, 444, and 445 indicating that the data cannot be found. At the same time (e.g., simultaneously), the resource management chip 415 proactive assigns resources to the pass-through chips 413 for broadcasting the request off-drawer, in 446. That is, rather than wait to receive notification from the requesting chip 412 of the decision to go off-drawer, the resource management chip 415 can detect the likely need to go off-drawer from the data request transmitted in 442, due to the modified bit/notification in the data request. In 447, the resource management chip 415 sends the assigned resources to the pass-through chips 413.

In 448, the requesting chip 412 combines the responses in 443, 444, and 445 from the pass-through chips, the other chips 414, and the resource management chip 415, and determines/confirms that the request needs to go off-drawer. In 449, the requesting chip 412 can notify the pass-through chips 413, the other chips 414, and the resource management chip 415, of the determination to go off-drawer, and the pass-through chips 413 can automatically transmit the data request to the other drawers (e.g., chips 422 in a drawer 420, chips 432 in a drawer 430, etc.) in 450, without a need to wait for resources to be assigned by the resource management chip 415. Thus, latency can be reduced by proactively assigning the resources to the pass-through chips 413 in steps 446 and 447.

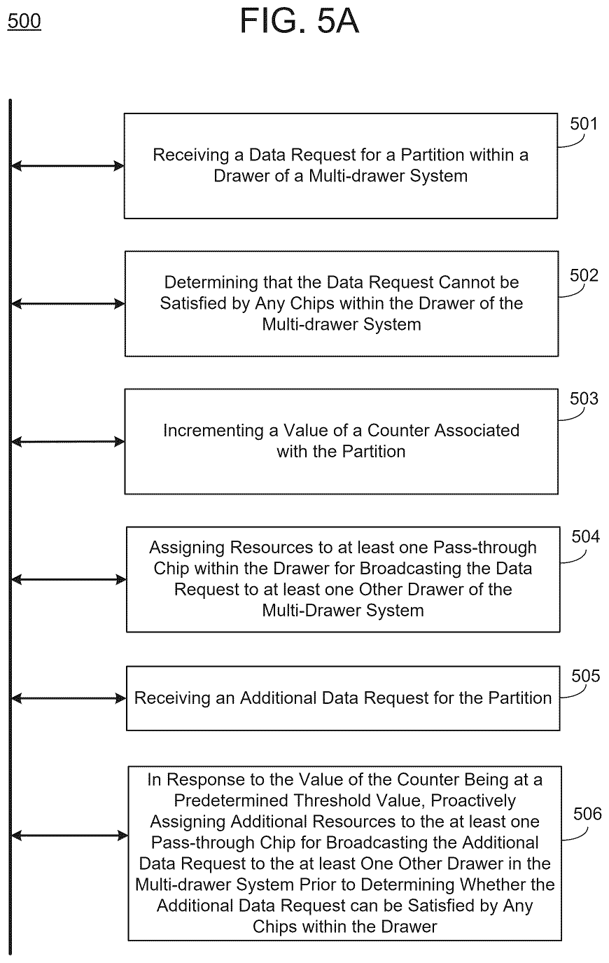

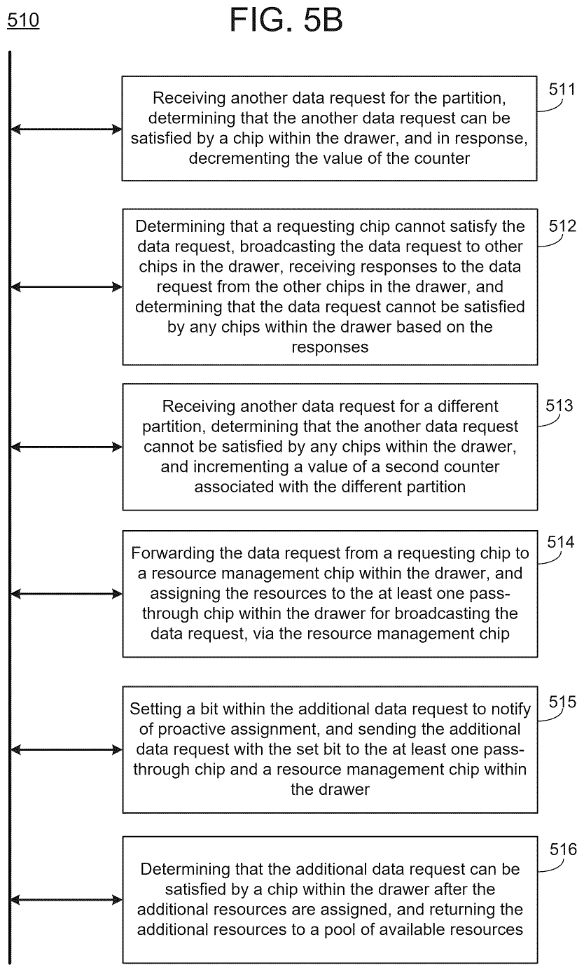

FIG. 5A illustrates a flow diagram of a method 500, according to example embodiments. Referring to FIG. 5A, in 501, the method may include receiving a data request for a partition within a drawer of a multi-drawer system. In 502, the method may include determining that the data request cannot be satisfied by any chips within the drawer of the multi-drawer system. In 503, the method may include incrementing a value of a counter associated with the partition. In 504, the method may include assigning resources to at least one pass-through chip within the drawer for broadcasting the data request to at least one other drawer of the multi-drawer system. In 505, the method may include receiving an additional data request for the partition. In response to the value of the counter being at a predetermined threshold value, in 506, the method may include proactively assigning additional resources to the at least one pass-through chip for broadcasting the additional data request to the at least one other drawer in the multi-drawer system prior to determining whether the additional data request can be satisfied by any chips within the drawer.

FIG. 5B illustrates a flow diagram of a method 510, according to example embodiments. Referring to FIG. 5B, in 511, the method may include receiving another data request for the partition, determining that the another data request can be satisfied by a chip within the drawer, and in response, decrementing the value of the counter. In 512, the method may include determining that a requesting chip cannot satisfy the data request, broadcasting the data request to other chips in the drawer, receiving responses to the data request from the other chips in the drawer, and determining that the data request cannot be satisfied by any chips within the drawer based on the responses. In 513, the method may include receiving another data request for a different partition, determining that the another data request cannot be satisfied by any chips within the drawer, and incrementing a value of a second counter associated with the different partition.

In 514, the method may include forwarding the data request from a requesting chip to a resource management chip within the drawer, and assigning the resources to the at least one pass-through chip within the drawer for broadcasting the data request, via the resource management chip. In 515, the method may include setting a bit within the additional data request to notify of proactive assignment, and sending the additional data request with the set bit to the at least one pass-through chip and a resource management chip within the drawer. In 516, the method may include determining that the additional data request can be satisfied by a chip within the drawer after the additional resources are assigned, and returning the additional resources to a pool of available resources.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

An exemplary storage medium may be coupled to the processor such that the processor may read information from, and write information to, the storage medium. In the alternative, the storage medium may be integral to the processor. The processor and the storage medium may reside in an application-specific integrated circuit (“ASIC”). In the alternative, the processor and the storage medium may reside as discrete components.

What is claimed is:

1. An apparatus comprising:
a memory; and
at least one processor coupled to the memory, the at least one processor configured to:
receive a data request for a partition within a drawer of a multi-drawer system,
determine that the data request cannot be satisfied by any chips within the drawer of the multi-drawer system,
increment a value of a counter associated with the partition,
assign resources to at least one pass-through chip within the drawer for broadcasting the data request to at least one other drawer of the multi-drawer system,
receive an additional data request for the partition, and
in response to the value of the counter being at a predetermined threshold value, proactively assign additional resources to the at least one pass-through chip for broadcasting the additional data request to the at least one other drawer in the multi-drawer system prior to determining whether the additional data request can be satisfied by any chips within the drawer.

2. The apparatus of claim 1, wherein the at least one processor is further configured to receive another data request for the partition, determine that the another data request can be satisfied by a chip within the drawer, and in response, decrement the value of the counter.

3. The apparatus of claim 1, wherein the at least one processor is configured to determine that a requesting chip cannot satisfy the data request, broadcast the data request to other chips in the drawer, receive responses to the data request from the other chips in the drawer, and determine that the data request cannot be satisfied by any chips within the drawer based on the responses.

4. The apparatus of claim 1, wherein the at least one processor is configured to receive another data request for a different partition, determine that the another data request cannot be satisfied by any chips within the drawer, and increment a value of a second counter associated with the different partition.

5. The apparatus of claim 1, wherein the at least one processor is configured to forward the data request from a requesting chip to a resource management chip within the drawer, and assign the resources to the at least one pass-through chip within the drawer for broadcasting the data request, via the resource management chip.

6. The apparatus of claim 1, wherein the at least one processor is configured to set a bit within the additional data request to notify of proactive assignment, and send the additional data request with the set bit to the at least one pass-through chip and a resource management chip within the drawer.

7. The apparatus of claim 1, wherein the at least one processor is further configured to determine that the additional data request can be satisfied by a chip within the drawer after the additional resources are assigned, and return the additional resources to a pool of available resources.

8. A method comprising:
receiving a data request for a partition within a drawer of a multi-drawer system;
determining that the data request cannot be satisfied by any chips within the drawer of the multi-drawer system;
incrementing a value of a counter associated with the partition;
assigning resources to at least one pass-through chip within the drawer for broadcasting the data request to at least one other drawer of the multi-drawer system;
receiving an additional data request for the partition; and
in response to the value of the counter being at a predetermined threshold value, proactively assigning additional resources to the at least one pass-through chip for broadcasting the additional data request to the at least one other drawer in the multi-drawer system prior to determining whether the additional data request can be satisfied by any chips within the drawer.

9. The method of claim 8, comprising receiving another data request for the partition, determining that the another data request can be satisfied by a chip within the drawer, and in response, decrementing the value of the counter.

10. The method of claim 8, comprising determining that a requesting chip cannot satisfy the data request, broadcasting the data request to other chips in the drawer, receiving responses to the data request from the other chips in the drawer, and determining that the data request cannot be satisfied by any chips within the drawer based on the responses.

11. The method of claim 8, comprising receiving another data request for a different partition, determining that the another data request cannot be satisfied by any chips within the drawer, and incrementing a value of a second counter associated with the different partition.

12. The method of claim 8, comprising forwarding the data request from a requesting chip to a resource management chip within the drawer, and assigning the resources to the at least one pass-through chip within the drawer for broadcasting the data request, via the resource management chip.

13. The method of claim 8, comprising setting a bit within the additional data request to notify of proactive assignment, and sending the additional data request with the set bit to the at least one pass-through chip and a resource management chip within the drawer.

14. The method of claim 8, comprising determining that the additional data request can be satisfied by a chip within the drawer after the additional resources are assigned, and returning the additional resources to a pool of available resources.

15. A computer-readable hardware storage medium comprising instructions which when executed by a processor cause the processor to perform:
receiving a data request for a partition within a drawer of a multi-drawer system;
determining that the data request cannot be satisfied by any chips within the drawer of the multi-drawer system;
incrementing a value of a counter associated with the partition;
assigning resources to at least one pass-through chip within the drawer for broadcasting the data request to at least one other drawer of the multi-drawer system;
receiving an additional data request for the partition; and
in response to the value of the counter being at a predetermined threshold value, proactively assigning additional resources to the at least one pass-through chip for broadcasting the additional data request to the at least one other drawer in the multi-drawer system prior to determining whether the additional data request can be satisfied by any chips within the drawer.

16. The computer-readable hardware storage medium of claim 15, wherein the processor is further configured to perform receiving another data request for the partition, determining that the another data request can be satisfied by a chip within the drawer, and in response, decrementing the value of the counter.

17. The computer-readable hardware storage medium of claim 15, wherein the processor is further configured to perform determining that a requesting chip cannot satisfy the data request, broadcasting the data request to other chips in the drawer, receiving responses to the data request from the other chips in the drawer, and determining that the data request cannot be satisfied by any chips within the drawer based on a combination of the received responses.

18. The computer-readable hardware storage medium of claim 15, wherein the processor is further configured to perform receiving another data request for a different partition, determining that the another data request cannot be satisfied by any chips within the drawer, and incrementing a value of a second counter associated with the different partition.

19. The computer-readable hardware storage medium of claim 15, wherein the processor is further configured to perform forwarding the data request from a requesting chip to a resource management chip within the drawer, and assigning the resources to the at least one pass-through chip within the drawer for broadcasting the data request, via the resource management chip.

20. The computer-readable hardware storage medium of claim 15, wherein the processor is further configured to perform setting a bit within the additional data request to notify of proactive assignment, and sending the additional data request with the set bit to the at least one pass-through chip and a resource management chip within the drawer.
